(19) United States
(12) Patent Application Publication
(10) Pub. No.: US 2002/0027172 A1
(43) Pub. Date: Mar. 7, 2002

(54) Automatic lawn feeder

(76) Inventor: Ralph Whiteley, Lancaster, CA (US)

Correspondence Address: Matthew J. Peirce, Esq., 1550 Starlight Canyon Avenue, Las Vegas, NV, 89123, US

(21) Appl. No.: 09/909,772

(22) Filed: Jul. 20, 2001

Related U.S. Application Data
(60) Provisional application No. 60/219,607, filed on Jul. 21, 2000.

(51) Int. Cl. B05B 7/26

(52) U.S. Cl. 239/310; 239/207; 239/201; 239/266

(57) ABSTRACT

A new and improved apparatus is disclosed to fertilize water passing through an existing irrigation system. The present invention would comprise at least one feeder, which would comprise an outer housing and an inner feeder tube. The inner feeder tube would be accessible via a top-mounted threaded end cap, with a user removing the top-mounted threaded end cap in order to place fertilizer within the inner feeder tube. The inner feeder tube would have holes throughout its length, and with the outer housing connected up to a closed irrigation water line, the fertilizer would be permitted to mix with the continuous flow of water that would pass through the feeder. Water in the entire irrigation system would be designed to pass through an input PVC line into the feeder, pass around and through the feeder tube (thereby picking up and dissolving fertilizer), and then passing through an output mechanism into the regular irrigation line. Then, the water would be sprayed out through one of many possible sprinkler heads that would be located on a user's yard.

### I. BACKGROUND OF THE INVENTION

The present invention concerns that of a new and improved apparatus to fertilize water passing through an existing irrigation system.

### II. DESCRIPTION OF THE PRIOR ART

U.S. Pat. No. 5,839,665, issued to DiVittorio, discloses a sprinkler system that includes multiple lawn chemical distributing assemblies that each include a pipe connector member having a water flow passageway formed from the length thereof

U.S. Pat. No. 5,772,115, issued to Vaughn, discloses a lawn and garden fertilizer distributing system which includes a tank having an aperture through a lower end thereof.

U.S. Pat. No. 5,364,030, issued to Murdock et al., discloses a solution injector for underground sprinkler systems which comprises an intake pipe connected with a bypass pipe at a system inlet pipe “T,” a tank, and an outflow pipe connected at one end to the tank and at the other to the bypass pipe.

### III. SUMMARY OF THE INVENTION

The present invention concerns that of a new and improved apparatus to fertilize water passing through an existing irrigation system. The present invention would comprise at least one feeder, which would comprise an outer housing and an inner feeder tube. The inner feeder tube would be accessible via a top-mounted threaded end cap, with a user removing the top-mounted threaded end cap in order to place fertilizer within the inner feeder tube. The inner feeder tube would have holes throughout its length, and with the outer housing connected up to a closed irrigation water line, the fertilizer would be permitted to mix with the continuous flow of water that would pass through the feeder. Water in the entire irrigation system would be designed to pass through an input PVC line into the feeder, pass around and through the feeder tube (thereby picking up and dissolving fertilizer), and then passing through an output mechanism into the regular irrigation line. Then, the water would be sprayed out through one of many possible sprinkler heads that would be located on a user's yard.

There has thus been outlined, rather broadly, the more important features of an apparatus for fertilizing water in an existing irrigation system in order that the detailed description thereof that follows may be better understood and in order that the present contribution to the art may be better appreciated. There are, of course, additional features of the apparatus for fertilizing water in an existing irrigation system that will be described hereinafter and which will form the subject matter of the claims appended hereto.

In this respect, before explaining at least one embodiment of the apparatus for fertilizing water in an existing irrigation system in detail, it is to be understood that the apparatus for fertilizing water in an existing irrigation system is not limited in its application to the details of construction and to the arrangements of the components set forth in the following description or illustrated in the drawings. The apparatus for fertilizing water in an existing irrigation system is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for fertilizing water in an existing irrigation system. It is important, therefore, that the claims be regard as including such equivalent constructions insofar as they do not depart from the spirit and scope of the present invention.

It is therefore an object of the present invention to provide an apparatus for fertilizing water in an existing irrigation system which has all of the advantages of the prior art and none of the disadvantages.

It is another object of the present invention to provide an apparatus for fertilizing water in an existing irrigation system which may be easily and efficiently manufactured and marketed.

It is another object of the present invention to provide an apparatus for fertilizing water in an existing irrigation system which is of durable and reliable construction.

It is yet another object of the present invention to provide an apparatus for fertilizing water in an existing irrigation system which is economically affordable and available to the buying public.

It is yet another object of the present invention to provide an apparatus for fertilizing water in an existing irrigation system which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention as it would appear hooked up to a standard irrigation line in a person's yard.

FIG. 2 shows a perspective view of the feeder tube of the present invention.

### V. DESCRIPTION OF THE PREFERRED EMBODIMENT

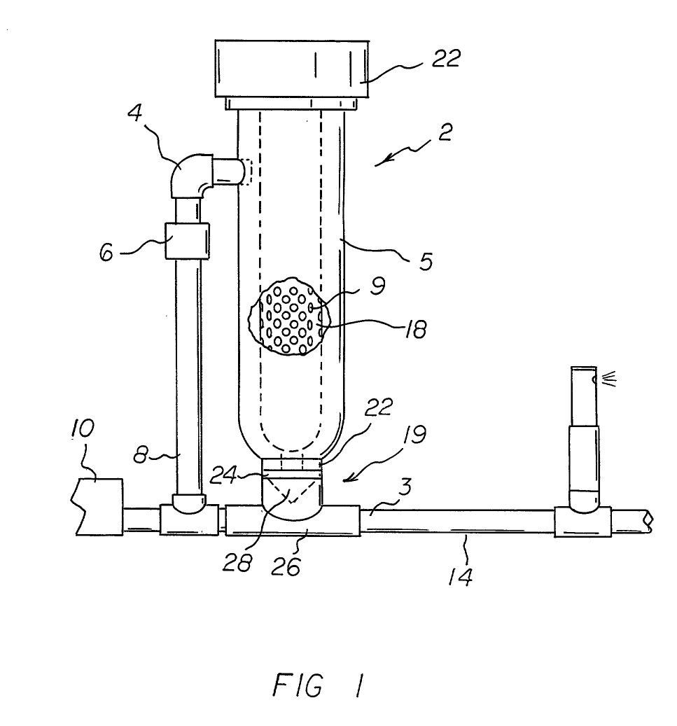

FIG. 1 shows a perspective view of feeder 2 as it would appear hooked up to a sprinkler line 14 of a standard irrigation line 3 in a person's yard. The present invention concerns that of a new and improved apparatus to fertilize water passing through an existing irrigation system. The present invention would comprise at least one feeder 2, which would comprise an outer housing 5 and an inner feeder tube 18. Inner feeder tube 18 would be accessible via a top-mounted threaded end cap 22, with a user removing the top-mounted threaded end cap 22 in order to place fertilizer 7 within the inner feeder tube 18. The inner feeder tube 18 would have a plurality of holes 9 throughout its length, and with the outer housing 5 connected up to a closed irrigation water line, the fertilizer 7 would be permitted to mix with the continuous flow of water that would pass through the feeder 2. Outer housing 5 would preferably be approximately 14 inches in length.

Water in the entire irrigation system would be designed to pass through a sprinkler valve 10 onto a PVC tube 8, where it would proceed to a mixing valve 6 and a PVC elbow 4 before entering the outer housing 5 of feeder 2. Then, the water would pass around the inside of outer housing 2 and would enter and exit feeder tube 18, where the water would come in contact with fertilizer 7, thereby picking up and dissolving fertilizer, and then passing through output mechanism 19 into the regular irrigation line.

Output mechanism 19 would comprise end cap 22, which would be drilled and taped with a ½ inch to ¾ inch bushing 24, and then spliced together with a ¾ inch tee 26 to entrap screen 28, which would be a conical-shaped screen. Upon leaving output mechanism 19, the water would reenter the standard irrigation line 3 and proceed onto one of many possible sprinkler heads that would be located on a user's yard.

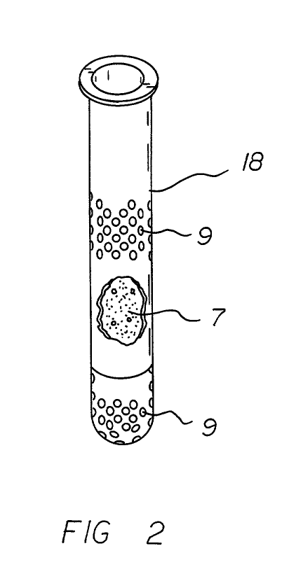

FIG. 2 shows a perspective view of a feeder tube 18 of the present invention. As can be seen, feeder tube 18 has a plurality of holes 9 dispersed evenly over its surface. The plurality of holes 9 would allow fertilizer 7, which would be placed inside of feeder tube 18, to interact with and dissolve with water that has passed through feeder 2.

1. An apparatus for fertilizing water passing through an irrigation system comprising:
(a) a main irrigation line,
(b) a volume of water within the main irrigation line,
(c) a pumping mechanism for pumping the volume of water through the main irrigation line,
(d) a feeder tube comprising an outer housing and an inner feeder tube, the outer housing and the inner feeder tube each having two ends, a first end and a second end, the first end of the outer housing and the first end of the inner feeder tube connected to the main irrigation line, the outer housing being approximately fourteen inches in length, the second end of the outer housing being open, the inner feeder tube having a plurality of holes dispersed evenly over its surface, the second end of the inner feeder tube being open, the inner feeder tube not having a length greater than the outer housing,
(e) a volume of fertilizer placed within the inside of the inner feeder tube,
(f) an end cap threadably attached to the second end of the outer housing,
(g) an inflow line having two ends, a first end and a second end, the first end of the inflow line connected to the main irrigation line, the second end of the inflow line connected to the outer housing,
(h) an outflow mechanism having two ends, a first end and a second end, the first end of the outflow mechanism connected to the first end of the outer housing the first end of the inner feeder tube, the second end of the outflow mechanism attached to the main irrigation line,
(i) at least one sprinkler head attached to the main irrigation line, and
whereby a user would place the volume of fertilizer within the inner feeder tube and threadably attach the end cap to the second end of the outer housing, further whereby the pumping mechanism would pump some water through the main irrigation line through the inflow line into the outer housing, whereby some of the volume of water would pass through the plurality of holes on the inner feeder tube and mix with the volume of fertilizer, whereby water would then pass through the outflow mechanism into the main irrigation line and then subsequently be emitted through at least one sprinkler head.

2. An apparatus for fertilizing water passing through an irrigation system according to claim 1 wherein the inflow line further comprises:
(a) a tube having two ends, a first end and a second end, the first end of the tube connected to the main irrigation line,
(b) a mixing valve connected to the second end of the tube, and
(c) an elbow having two ends, a first end and a second end, the first end connected to the mixing valve, the second end of the elbow connected to the outer housing.

3. An apparatus for fertilizing water passing through an irrigation system according to claim 1 wherein the outflow mechanism further comprises:
(a) an end cap,
(b) a conical screen attached to the end cap,
(c) a bushing attached to the end cap, the bushing fixedly holding the conical screen in place, and
(d) a T-joint attached to the end cap, the T-joint also attached to the main irrigation line.

4. An apparatus for fertilizing water passing through an irrigation system according to claim 3 wherein the T-joint has an inner diameter of three-fourths of an inch.
